(19) United States
(12) Patent Application Publication
(10) Pub. No.: US 2008/0059809 A1
(43) Pub. Date: Mar. 6, 2008

(54) Sharing a Secret by Using Random Function

(75) Inventor: Marten Erik Van Dijk, Cambridge, MA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,313

(22) PCT Filed: Sep. 16, 2005
(86) PCT No.: PCT/IB05/53047

§ 371 Date: Mar. 15, 2007

Related U.S. Application Data
(60) Provisional application No. 60/611,386, filed on Sep. 20, 2004.

(51) Int. Cl. H04L 9/08

(52) U.S. Cl. 713/190

(57) ABSTRACT

A physical random function (PUF) is a function that is easy to evaluate but hard to characterize. Controlled physical random functions (CPUFs) are PUFs that can only be accessed via a security program controlled by a security algorithm that is physically bound to the PUF in an inseparable way. CPUFs enable certified execution, where a certificate is produced that proves that a specific computation was carried out on a specific processor In particular, an integrated circuit containing a CPUF can be authenticated using Challenge-Response Pairs (CRPs). The invention provides a mechanism to generate a shared secret between different security programs running on a CPUF.

The invention relates to a method to generate a shared secret between a first security program and at least a second security program, to a system arranged to implement such a method, to a computer program product for implementing such a method, to computer executable instructions for implementing such a method, and to a signal carrying results generated by such a method.

In applications such as electronic transactions it may be required to verify that a computation (or program) has actually been executed on a specific processor, either by a user or by a third party. In “Controlled Physical Random Functions”, by Blaise Gassend and Dwaine Clarke and Marten van Dijk and Srinivas Devadas, Proceedings of the 18th Annual Computer Security Applications Conference, December, 2002 (further referred to as “prior art document”), a framework is defined for generation and verification of challenge-response pairs that are tied to a PUF. A Physical Random Function (PUF) is a random function that is evaluated with the help of a complex physical system. The use of the abbreviation PUF (instead of PRF) has the advantage of being easier to pronounce, and it avoids confusion with Pseudo-Random Functions. PUFs can be implemented in different ways. Some of the implementations of PUFs are easy to produce in such a way that each production sample (for example each individual semiconductor chip) implements a different function. This enables a PUF to be used in authenticated identification applications.

A PUF is a function that maps challenges to responses, that is embodied by a physical device, and that has the following two properties: (1) the PUF is easy to evaluate: the physical device is easily capable of evaluating the function in a short amount of time, and (2) the PUF is hard to characterize: from a polynomial number of plausible physical measurements (in particular, determination of chosen challenge-response pairs), an attacker who no longer has (access to) the security device, and who can only use a polynomial amount of resources (time, matter, etc. . . . ) can only extract a negligible amount of information about the response to a randomly chosen challenge. In the above definition, the terms short and polynomial are relative to the size of the device, which is the security parameter. In particular, short means linear or low degree polynomial. The term plausible is relative to the current state of the art in measurement techniques and is likely to change as improved methods are devised.

Examples of PUFs are Silicon PUFs (Blaise Gassend and Dwaine Clarke and Marten van Dijk and Srinivas Devadas, Silicon Physical Random Functions, Proceedings of the 9th ACM Conference on Computer and Communications Security, November, 2002), Optical PUFs (P. S. Ravikanth, Massachusetts Institute of Technology, Physical One-Way Functions, 2001), and Digital PUFs. Silicon PUFs use inter-chip variations that are due to the manufacturing process. Optical PUFs employ the unpredictability of the speckle pattern generated by optical structures that are irradiated with a coherent light (laser) beam. Digital PUFs refer to the classical scenario where a tamper resistant environment protects a secret key, which is used for encryption and authentication purposes.

A PUF is defined to be Controlled (a controlled PUF or CPUF) if it can only be accessed via a security algorithm that is physically linked to the PUF in an inseparable way within a security device (i.e., any attempt to circumvent the algorithm will lead to the destruction of the PUF). In particular this security algorithm can restrict the challenges that are presented to the PUF and can limit the information about responses that is given to the outside world. Control is the fundamental idea that allows PUFs to go beyond simple authenticated identification applications.

An example of a CPUF is described in the prior art document. A security program is used under control of the security algorithm, linked to the PUF, such that the PUF can only be accessed via two primitive functions GetSecret(.) and GetResponse(.) from the security program. GetSecret(.) ensures that the input to the PUF depends on a representation of the security program from which the primitive functions are executed. GetResponse(.) ensures that the output of the PUF depends on a representation of the security program from which the primitive functions are executed. Because of this dependence, the input to the PUF and output of the PUF will be different if these primitive functions are executed from within a different security program. Furthermore, these primitive functions ensure that the generation of new challenge-response pairs can be regulated and secure, as is also described in the prior art document.

However, as the output of these primitive functions depends on a representation of the security program, they can not be used to generate a shared secret between different security programs running on the same PUF.

It is therefore an object of the invention to provide a method that allows generating a shared secret between different security programs.

This object is realized by a method to generate a shared secret between a first security program and at least a second security program, comprising: a step of executing program instructions under control of the first security program on a security device comprising a random function, the random function being accessible only from a security program through a controlled interface, the controlled interface comprising at least one primitive function accessing the random function that returns output that depends on at least part of a representation of the first security program that calls the primitive function, and at least part of a representation of the second security program that calls, upon executing the second security program on the security device, the primitive function, the step comprising a substep that calls the at least one primitive function to generate the shared secret. A shared secret can thus be established between two or more security programs, by each security program calling the primitive function with as input both a representation of the security program from which the primitive function is called, and (a) representation(s) of the other security program(s) with which the secret is to be shared. Because each of these security programs uses, as input to the primitive function, the representations of the involved security programs, the same secret is generated by each of these security programs.

By making the output depend on a representation of the security program, it is (almost) guaranteed that any other security program that is run con the security device, obtains different results for the same input through the controlled interface. Any other security program, for example designed by a hacker to obtain the shared key, obtains (with a high probability depending on the representation method) only useless results through the controlled interface because the results depend on the security program representation, which is different for the original security program and the other security program used by the hacker. No other security program can access the random function in a way that regenerates the secret key and compromises the security offered by the random function.

The representation of the security program could be a hash or other signature, or a part thereof. Normally, the representation of the security program covers the complete security program, but in special cases (for example where the security program contains large parts that don't concern the random function) it might be advantageous to limit the representation to those parts of the security program that handle the calling and handling of the input and output of the primitive functions.

The security program is typically provided by the user of the security device. As an alternative, the security program could also be provided by a separate program library within the security device.

To allow quick retrieval of a specific security program for later use, the program code could therefore be stored, or a hash code thereof, for subsequent execution of the security program, optionally together with information about permission who is allowed subsequent execution.

A more specific implementation of the invention is described in claim 2. The program representations are all used as input to the random function, either explicitly for the programs Prog1 . . . ProgN, or implicitly for the program Program from which the primitive function is called. To achieve this, the primitive function must be such that no distinction is made between the representation of the security program calling the primitive function and the other security program(s). A lexicographic ordering is applied to ensure that the different security programs generate the same shared secret.

A more specific implementation of the invention is described in claim 3. When a random hash function h(.) is used, which is preferably (almost) collision-free, these primitive functions can be used to advantage to reliably generate a key which is used as shared key between the security programs. It should be understood that, as described in claim 1, Program and Prog1 . . . ProgN represent only the relevant parts (from a security point of view) of the security program(s).

A variation of the invention is described in claim 4. Instead of having to compute the lexicographic ordering as in claim 2, this variation relies on the security programs being numbered, such that the program representations can easily be re-ordered into the same order in the respective security programs before being used as input to the primitive function.

A variation of the invention is described in claim 5. Patent application US2004/014404 [attorney docket PHNL030605], filed May 6, 2004, describes a proof of execution which is generated by a security program running in a first mode, and which can be I verified by the same security program running in a second mode. The disadvantage of that solution is that the complete security program containing both modes needs to be available at the security device for execution and for use in the primitive function. The method according to the current invention has the advantage that only the first-mode part or the second-mode part is required as a separate security program, while the security is still available as each of the security programs is still able to generate a shared secret.

A variation of the invention is described in claim 6. Patent application US2004/014404 [attorney docket PHNL030605], filed May 6, 2004, describes further the concept of secure status information by a security program, conceived for later continuation of the security program. This concept can be used to schedule two or more security programs, which effectively allows multiple security programs to run on a security device. These different security programs can communicate securely using the shared secret key obtained with the method according to the invention.

An advantageous implementation of the invention is described in claim 7. In the prior art document certified execution is defined as a process that produces, together with the computation output, a certificate (called e-certificate) which proves to the user of a specific processor chip that a specific computation was carried out on that specific processor chip, and that the computation was executed and did produce the given computation output. In order to prove to a user of a security device that the security program is actually performed on the same security device, the security program is preferably executed as part of a second security program, the second security program implementing certified execution as described in the prior art document.

A more specific implementation of the invention is described in claim 8. In this implementation a PUF is used for implementing the random function that is used in the primitive functions.

A more specific implementation of the invention is described in claim 9. The generated shared secret key in this implementation also depends on at least part of the input variables. This has the advantage that (application) program inputs do not have to be hard-coded in the security program in order to be used for the generation of the shared secret. Not all inputs need to be considered, as some inputs may not be of interest, should remain confidential between security device and user of the security device (and thus not be communicated to a third party), or should be allowed to be different between different program executions.

The system according to the invention is characterized as described in claim 10.

The computer program product, such as a computer readable medium, according to the invention is characterized as described in claim 11.

The signal according to the invention is characterized as described in claim 12.

These and other aspects of the invention will be further described by way of example and with reference to the schematic drawings, in which:

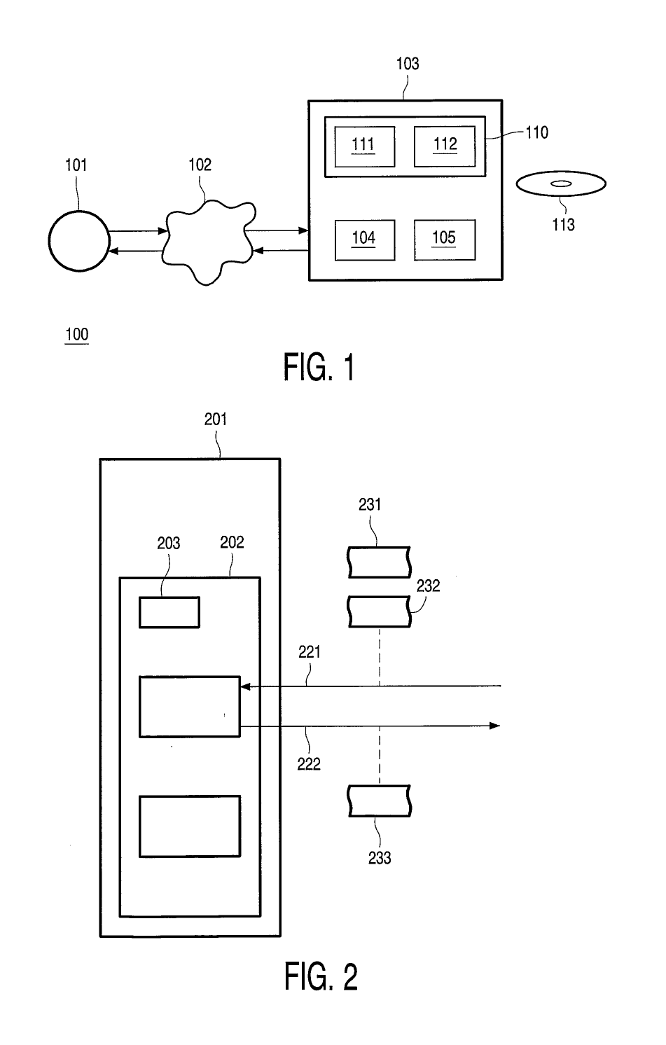

FIG. 1 illustrates the basic model for applications using the PUF,

FIG. 2 illustrates generation of a shared secret,

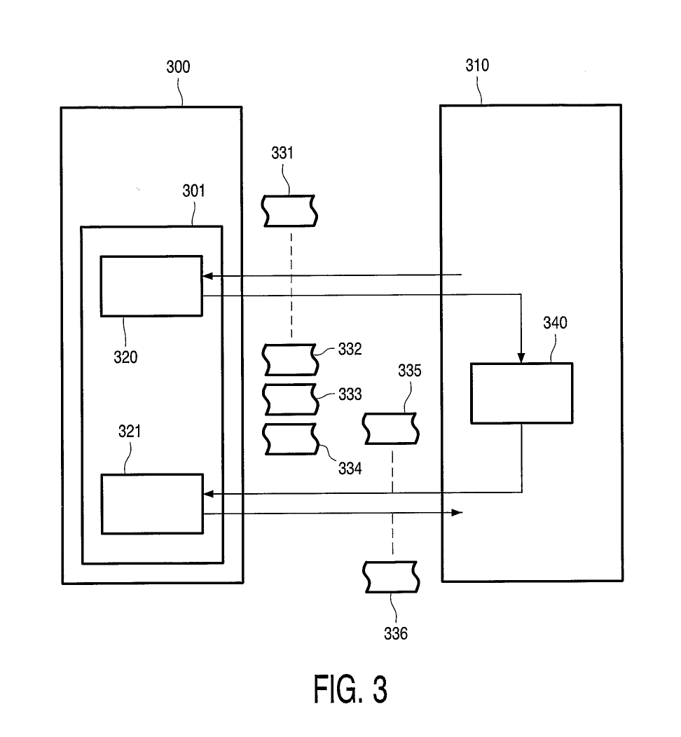

FIG. 3 illustrates an example usage scenario for generation of a shared secret, and

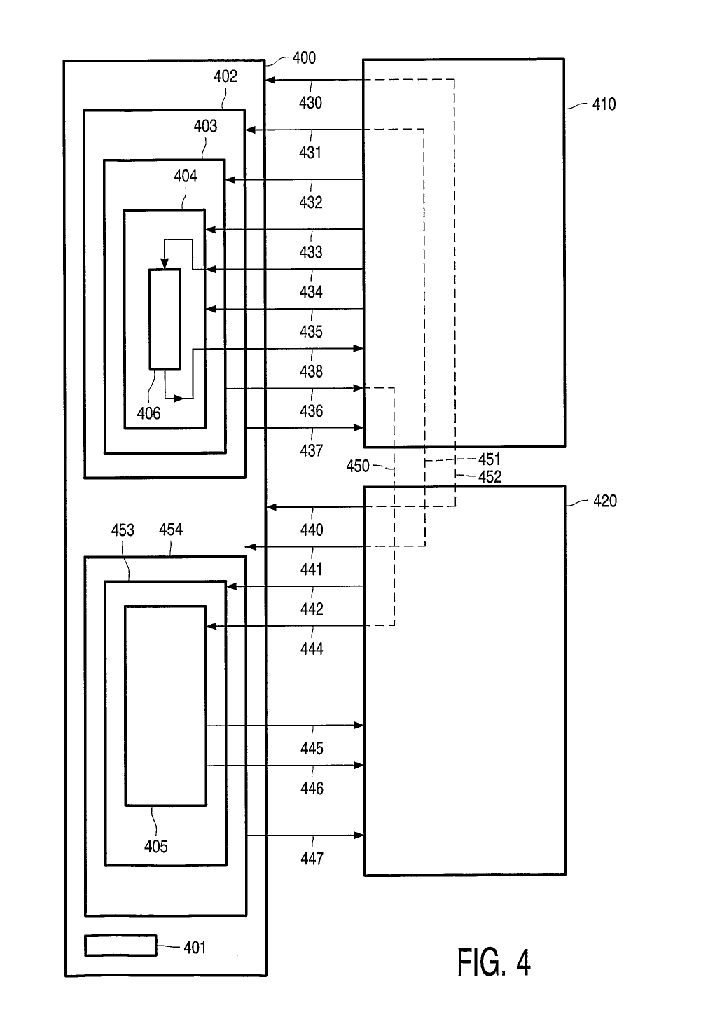

FIG. 4 illustrates an overview of the different program layers for generating a shared secret under certified execution,

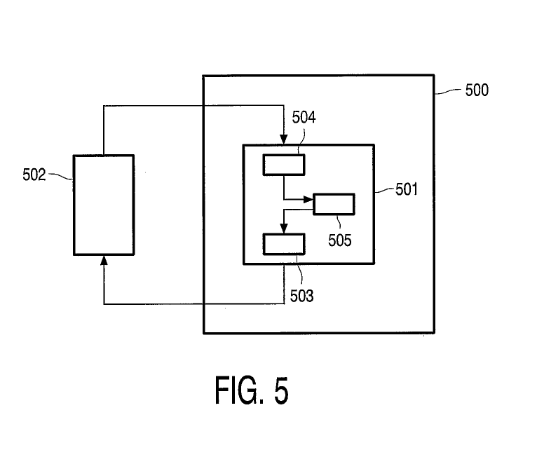

FIG. 5 illustrates interrupted processing, and

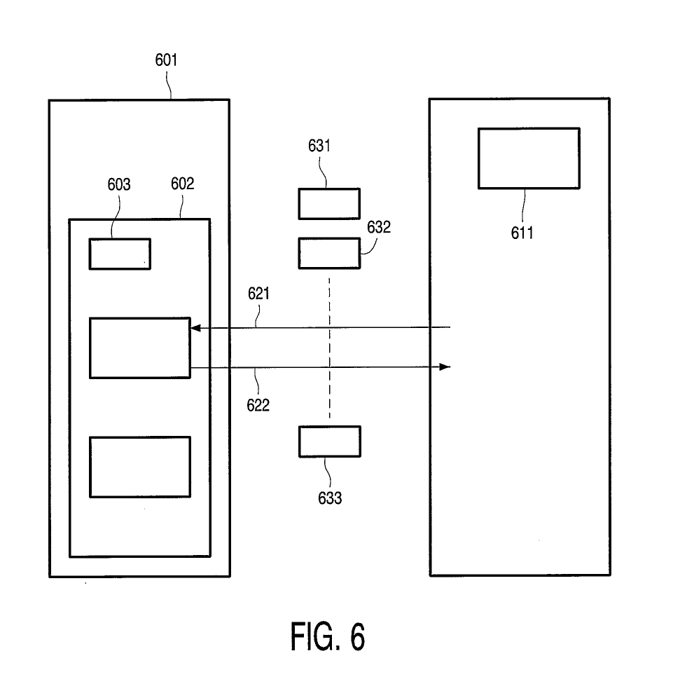

FIG. 6 illustrates certified execution.

Throughout the figures, same reference numerals indicate similar or corresponding features. Some of the features indicated in the drawings are typically implemented in software, and as such represent software entities, such as software modules or objects.

FIG. 1 illustrates the basic model for applications using security device 103 comprising a PUF 104 according to the prior art. The model, implemented by the system 100, comprises:

A user 101 who wants to make use of the computing capabilities of a chip 105 in or under control of a security device 103.

The user and the chip are connected to one another by a possibly untrusted public communication channel 102. The user can not only be a person, but also a different piece of software, hardware, or other device.

Security device 103 could be implemented by a processing device 110 comprising a processor 111 and memory 112, the processing device arranged for executing computer executable instructions from a computer program product 113.

The prior art document describes the handling of Challenges and Responses which are unique for each specific PUF. Given a challenge, a PUF can compute a corresponding response. A user is in possession of her own private (certified) list of CRPs (challenge-response pairs) originally generated by the PUF. The list is private because (besides the PUF perhaps) only the user knows the responses to each of the challenges in the list. The user's challenges can be public. It is assumed that the user has established several CRPs with the security device.

The responses to (a limited number of) the challenges are only known to the user. Additionally, the security device may (re)compute the response for a specific challenge. To prevent other persons to recover the response for a specific challenge, a secure way of managing the CRPs is needed. The prior art document proposes the concept of a Controlled PUF to achieve this. A PUF is defined to be Controlled (a controlled PUF or CPUF) if it can only be accessed via a security algorithm that is physically linked to the PUF in an inseparable way (i.e., any attempt to circumvent the algorithm will lead to the destruction of the PUF). In particular this security algorithm can restrict the challenges that are presented to the PUF and can limit the information about responses that is given to the outside world. Control is the fundamental idea that allows PUFs to go beyond simple authenticated identification applications. PUFs and controlled PUFs are described and known to implement smartcard identification, certified execution and software licensing.

To prevent man-in-the-middle attacks, a user is prevented from asking for the response to a specific challenge, during the CRP management protocols. This is a concern in the CRP management protocols, as, in these protocols, the security device sends responses to the user. This is guaranteed by limiting the access to the PUF, such that the security device never gives the response to a challenge directly. CRP management occurs as described in the prior art document. In the application protocols, the responses are only used internally for further processing such as to generate Message Authentication Codes (MACs), and are never sent to the user. The CPUF is able to execute some form of program, (further: a security program), in a private way (nobody can see what the program is doing, or at least the key material that is being manipulated remains hidden) and authentic way (nobody can modify without being detected what the program is doing).

The CPUF's control is designed such that the PUF can only be accessed via a security program, and more specifically by using two primitive functions GetResponse(.) and GetSecret(.). A set of primitive functions which are used in the prior art document is defined as:

GetResponse(PC)=f(h(h(SProgram),PC))

GetSecret(Challenge)=h(h(SProgram),f(Challenge))

where f is the PUF and h is a publicly available random hash function (or in practice some pseudo-random function). In these primitive functions, SProgram is the code of the security program that is being run in an authentic way. The user of the device may deliver such a security program. Note that h(Sprogram) includes everything that is contained in the program, including hard-coded values (such as, in some cases, Challenge). The security device calculates h(SProgram), and later uses this value when GetResponse(.) and GetSecret(.) are invoked. The computation of h(SProgram) can be done Oust) before starting the security program, or before the first instantiations of a primitive function. As shown in the prior art document, these two primitive functions are sufficient to implement secure CRP management where GetResponse(.) is essentially used for CRP generation while GetSecret(.) is used by applications that want to produce a shared secret from a CRP.

In the sequel, the following notations are used:

E(m,k) is the encryption of message m with the key k.

D(m,k) is the decryption of message m with the key k.

M(m,k) MACs message m with key k.

E&M(m,k) encrypts and MACs message m with the key k.

D&M(m,k) decrypts message m with the key k if the MAC matches. If the MAC does not match, it outputs the message that the MAC does not match and it does not perform any decryption.

A first embodiment of the invention, as shown in FIG. 2, shows an example of executing a security program generating a shared secret. The security program 231 is sent in communication 221 to the system 201 comprising a security device 202, which has a PUF 203, for execution, together with input 232 for the security program, comprising the hash code representation(s) of the other security program(s) (in this example: h_SprogB=h(SProgB)) with which a shared key is to be generated. Subsequently, security program SprogA generates a shared secret on a security device, using the primitive functions, according to the current invention, defined as:

GetResponseSK(PC)=f(h(PHR,PC)), and

GetSecretSK(Challenge)=h(PHR,f(Challenge)),

where

PHR=Ordering(h(Sprogram), Val, Rule).

The function Ordering defines, according to the value of Rule, a reordering of the input parameters. The value of Rule can be used to ensure that PHR and therefore the output of the primitive functions is the same in the different security programs that wish to generate a shared secret. The generated shared secret can subsequently be used as a secret key. The ordering function can be either a lexicographic ordering of the representation values of the security programs, or the value of Rule may determine the order in which these values are concatenated.

```
Program SProgA:
begin program
    \\ Initialization of Rule and Val,
    \\ used as input in GetSecretSK and GetResponseSK
    Rule = 0;
    Val = (h_SProgB);
    \\ GetSecretSK and GetResponseSK are now defined
    ...
    Main body of SProgA
    ...
    \\ GetSecretSK or GetResponseSK statements
    ...
end program
Program SProgB:
begin program
    \\ Initialization of Rule and Val,
    \\ used as input in GetSecretSK and GetResponseSK
    Rule = 1;
    Val = (h_SProgA);
    \\ GetSecretSK and GetResponseSK are now defined
    ...
    Main body of SProgA
    ...
    \\ GetSecretSK or GetResponseSK statements
    ...
end program
```

In program SProgA h(Ordering(h(ProgA),Val,Rule))=h(Ordering(h(ProgA),h(ProgB),0))=h(h(ProgA),h(ProgB)). In program SProgB h(Ordering(h(ProgB),Val,Rule))=h(Ordering(h(ProgB),h(ProgA),1))=h(h(ProgA),h(ProgB)). So both programs apply the same input to the primitive functions GetResponseSK.

A second embodiment of the invention illustrates the use of a shared secret for having separate security programs for the generation and for the verification of a proof of execution. Patent application US 2004/014404 [attorney docket PHNL030605], filed May 6, 2004, describes generation and verification of a proof of execution, using a multi-mode security program, of which a first mode generates the proof of execution, and of which a second mode verifies the proof of execution. According to the current invention, it is now possible to generate proof of execution and to verify the proof of execution using separate security programs, thereby reducing the overhead of program download and initialization. It may also reduce the computational load of the security program representation computation.

In order to support proof of execution, it is advantageous to extend the solution of certified execution with an additional program layer for generating a proof of execution.

As a first example where this embodiment can be used, consider a STB (set-top-box) application where Alice is the broadcaster 310 and Bob is the owner of the STB 300 with a security device 301, see FIG. 3. In program A 320 Bob buys a service. Alice receives the transaction details 332, an e-certificate 333 (the e-certificate verifies the authenticity of both the transaction details and e-proof), and an e-proof 334. Alice checks in step 340 whether the e-certificate matches. If so, she knows that e-proof was generated by Bob's STB and she continues the transaction in program B. The e-proof can be used as a confirmation that Bob has bought the service because an arbiter can recover the transaction details. In program B 321, Bob receives the content 335 belonging to the service he requested. The content may be encrypted by using a CRP. Alice receives a second e-proof 336 of Bob's actions in program B. In first instance, it seems as if Bob does not receive a proof of Alice's promise to send him the content in program B. However, not only Alice but also Bob can use the first e-proof. Any third party will be able to check that Bob's STB successfully performed the protocol encoded in program A, which is in itself Alice's promise to transmit the content to Bob in program B. For example, Bob can use the e-proof to convince third parties (and in particular Alice) that he bought a certain service, which may make him eligible for discounts and upgrades.

As a second example, suppose Alice wants to execute a program on Bob's security device with a time stamp as part of its input. The results of the execution may contain a copy of this time stamp with Bob's agreement that the time stamp represents the correct time of execution. For example, the program is designed such that it asks Bob if he agrees and aborts if Bob does not agree. Given a correct e-proof, an arbiter retrieves the results. Hence, he can check the time stamp and verify whether Bob and/or Alice's claims are still valid.

As a third example, assume a program Program′ with different modes. Depending on its mode, Program′ computes either (Result,EProof)=Program(Input) on processor P, where BProof is an e-proof for program Program with input Input on P, or Program′ plays the role of arbiter checking whether EProof is a valid e-proof and, if so, it reconstructs Result. In the role of arbiter, EProof may be used as a ticket to the next mode in Program′. This technique implements conditional access.

FIG. 4 illustrates the different program layers. The programs according to the invention that generates respectively verifies the proof of execution, EProgramngeneration 403 and EProgram-verification 453, are each executed as the XProgram part of their respective certified execution programs CProgram1 402 and 454 in a security device 400 with a PUF 401, in order that both the user and the third party are convinced that the execution took place on the security device.

EProgram_generation computes not only (in AProgram 406) the results in which Alice is interested but also an e-proof. Alice uses certified execution (by running EProgram_generation as the XProgram part of CProgram) to be sure that the program was executed correctly on Bob's security device. An arbiter can check the e-proof by running the EProgram-verification, also using certified execution. The key idea is that the i GetResponse(.) primitive depends on the hash of both security programs. Consequently, the e-proof which was generated by the security program for generating a proof of execution (with a key obtained through the GetResponse(.) primitive) can be decrypted by the security program for verification of the proof of execution.

Security is determined by, firstly, the difficulty of breaking the GetResponse(.) primitive, that is breaking the hash and breaking the PUF with which GetResponse(.) is defined, and, secondly, the difficulty to break the encryption and MAC E&M(.) primitive.

Variations in these programs are possible: some programs may hard-code part of the input, which is less flexible but more robust. The amount of output present in the proof results is also different. Any variation of these algorithms can be implemented.

In a first variation, Alice wants to run AProgram(Input) and receive a proof of execution and therefore runs EProgram_generation(Inputs) (431) where Inputs=(h(EProgram_verification),AProgram,Input,PC) (with 435: AProgram, 434: Input), with Val 432 equal to h(EProgram_verification) and PC 433 a random string, and where EProgram_generation is as defined below. PC is used by GetResponse(.) as a “pre-challenge” to compute the challenge for the random function, in order to generate the secret keys KE. Alice uses the technique of certified execution to execute EProgram_generation(Inputs) on Bob's security device using a CProgram 430 as described before. Alice checks the e-certificate to verify the authenticity of all the output that it gets back from the security device. The produced e-certificate is not only a certificate of the result 438 generated by Program(Input) but also of the generated e-proof 436.

```
EProgram_generation(Inputs):
begin program
var Val,AProgram,Input,PC,Rule,Result,KE, EMResult,EProof,Results;
    (Val,AProgram,Input,PC)=Inputs;
    Rule=0;
    // GetResponseSK( ) now defined
    Result=AProgram(Input);
    KE=GetResponseSK(PC);
    EMResult=E&M(Result,KE);
    EProof=(PC,EMResult);
    Results=(Result,EProof);
end program
EProgram_verification(Inputs):
begin program
var Val, Eproof, Rule, PC, EMResult, KA, Result, CheckBit, Results;
    (Val,EProof)=Inputs;
    Rule=1;
    // GetResponseSK( ) is now defined
    (PC,EMResult)=EProof;
    KA=GetResponseSK(PC);
    Result=D&M(EMResult,KA);
    CheckBit=(MAC of EMResult matches);
    Results=(Result,CheckBit);
    Output(Results);
end program
```

The proof of execution can be verified by any arbiter executing the protocol with Bob's security device, the verification comprising three steps. In step 1 the arbiter receives from Alice or Bob a proof of execution EProof in step 450. He constructs Inputs=(h(EProgram_generation),EProof) (EProof: 444), where Val 442 is the security program representation required to generate the shared secret key. The arbiter also obtains the EProgram_verification and CProgram (as presumably executed before; in this example communicated to the arbiter in step 451 and step 452), probably from Alice or Bob. Note that the arbiter doesn't need PC.

In step 2 the arbiter uses the technique of certified execution with CProgram 440 to execute EProgram_verification(Inputs) (EProgram_verification: 441) on Bob's security device. The arbiter checks the e-certificate 447 to verify the authenticity of Results that it gets back from the security device. If the e-certificate matches with Results then the arbiter knows that Bob's security device executed EProgram_generation(Inputs) without anybodies interference and that nobody tampered with its inputs or outputs. In particular nobody modified the input EProof. In other words, Bob's security device executed EProgram_verification(Inputs) using EProof. Result 445 can be supplied completely, partly, or not at all in the Output. It can also be replaced by information derived from the Result. This may depend on the application and on the arbiter. This decision is then implemented in the program. For example, for privacy reasons the EProgram_verification could send only a summary of the results to the arbiter.

In step 3 the arbiter verifies whether CheckBit 446 is true, that is whether the MAC of EMResult matches. If so, the arbiter decides that AProgram(Input) on Bob's security device has computed EProof and Result. If not, the arbiter decides Bob's security device has not computed EProof. EProgram_verification either outputs that the MAC does not match (see the definition of D&M(.) and CheckBit), or outputs that the MAC does match together with a decrypted result. To generate a fake c-proof FEProof=(FPC,FEMResult) for a (fake) result FResult is a so-called difficult problem.

In a third embodiment, the use of secure memory and secure program execution state as described in the patent application US2004/014404 [attorney docket PHNL030605], filed May 6, 2004, can be combined with shared secret generation to communicate securely between security programs that run alternating on the same security device.

FIG. 5 illustrates the architecture for this embodiment. Program execution state 502 and memory content 502 are stored in between partial executions of a security program 505. A security program 501 running on the security device 500 is able to securely store its program state 505 in case of an interrupt or if a different security program needs to run. Upon interruption, the program state is encrypted (step 503). The security device may continue its execution at a later moment without ever having revealed its state to the outside world. Upon continuation, the program state is verified and decrypted (step 504) and restored. A part of the memory content may be encrypted using a shared secret key, while another part of the memory may be encrypted using a private shared secret key, thereby implementing both secure inter-program communication and secure separation between security programs.

A fourth embodiment of the current invention adds the layer of certified execution. The concept of certified execution is described in the prior art document. In order to ensure the user of a security device that the security program is actually and securely executed on the security device, the security program that generates a shared secret is executed under control of another security program that implements certified execution. This technology will be illustrated by a specific implementation. Certified execution is provided using a so-called e-certificate. An e-certificate for a program XProgram with input Input on a security device is defined as a string efficiently generated by XProgram(Input) on the security device such that the user of the security device can efficiently check with overwhelming probability whether the outputted results of XProgram were generated by XProgram(Input) on the security device. The user who requests execution of XProgram on the security device can rely on the trustworthiness of the security device manufacturer who can vouch that he produced the security device, instead of relying on the owner of the security device.

FIG. 6 illustrates certified execution, in which the computation is done directly on the security device. A user, Alice, wants to run a computationally expensive program Program(Input) on Bob's computer 601. Bob's computer has a security device 602, which has a PUF 603. It is assumed that Alice has already established a list of CRPs 611 with the security device. Let (Challenge,Response) be one of Alice's CRPs for Bob's PUF. In a first implementation variation, Alice sends (in communication 621) the following program CProgram1 631, with input Inputs 632 equal to (Challenge,E&M((XProgram,Input),h(h(Cprogram),Response))), to the security device 602.

CProgram1(Inputs):

```
begin program
var Challenge,EM,XProgram,Input,Result,Certificate;
    (Challenge,EM)=Inputs;
    Secret=GetSecret(Challenge);
    (XProgram,Input)=D&M(EM,Secret);
    Abort if the MAC does not match;
    Result=XProgram(Input);
    Certificate=M(Result,Secret);
    Output(Result,Certificate);
end program
```

By Result=XProgram(Input) it is understood that Result is part of the output of XProgram(Input). There may be more output for which no e-proof is needed. Output( . . . ) is used to send results 633 out of the CPUF as shown in communication 622. Anything that is sent out of the security device is potentially visible to the whole world (except during bootstrapping, where the manufacturer is in physical possession of the security device). A secure design of the program generates a result which is placed in encrypted form in Result. The encryption can be done by means of classical cryptography or by using Secret In the latter case, Secret is contained in Input.

Because Alice's CRP is private, no other person can generate Secret and, hence, a MAC with Secret. A MAC is used at two spots in the program. The first MAC is checked by the program and guarantees the authenticity of Inputs. The second MA-C is checked by Alice and guarantees the authenticity of the message that it gets back from the security device. Apart from Alice only the security device can generate Secret given Challenge by executing the program CProgram. This means that Result and Certificate were generated by CProgram on the security device. In other words CProgram performed the certified execution with Inputs as input. This proves that Certificate is an e-certificate.

It follows that e-certificates can be used for secure remote computation of a security program that generates a shared secret. If Certificate matches, then this proves to Alice that XProgram(Input) was executed (by CProgram(Inputs)) on the security device.

It is noted that the owner of the security device (Bob) and the user of the security device (Alice) may be one and the same identity. For example, Bob prove s to others by means of his e-proof that he computed Result with Program(Input). Finally, it is an advantage of the invention that neither Alice or the Arbiter needs a PUF equipped security device.

The invention is generally applicable in the sense that it can be applied to all PUFs, digital as well as physical or optical. The details of the construction are given for physical PUFs but can be transferred to digital or optical PUFs.

Alternatives are possible. In the description above, “comprising” does not exclude other elements or steps, “a” or “an” does not exclude a plurality, and a single processor or other unit may also fulfill the functions of several means recited in the claims.

1. Method to generate a shared secret between a first security program and at least a second security program, comprising:
a step of executing program instructions under control of the first security program (403) on a security device (103,202) comprising a random function (104,203), the random function being accessible only from a security program through a controlled interface,
the controlled interface comprising at least one primitive function accessing the random function that returns output that depends on
at least part of a representation of the first security program that calls the primitive function, and
at least part of a representation of the second security program that calls, upon executing the second security program on the security device, the primitive function,
the step comprising a substep that calls the at least one primitive function to generate the shared secret.

2. The method of claim 1, wherein the representation of the first security program and the representation of the second security program are lexicographically ordered when used as inputs of the primitive function.

3. The method of claim 2, wherein the random function is accessible via a primitive function and substantially equals
GetResponse( . . . )=f(h(o(h(Program),hprog1, . . . ,hprogN),PC),
where
Program is the security program calling the primitive function,
hprog1 . . . hprogN are equal to h(Program 1) . . . h(ProgramN),
Program1 . . . ProgramN are the security programs with which the key is to be shared,
f(.) is the random function,
h(.) is substantially a publicly available random hash function, and
o( . . . ) performs a lexicographic ordering of the arguments.

4. The method of claim 1, wherein the random function is accessible via a primitive function
GetResponse( . . . )=f(h(o(h(Program),hprog1, . . . ,hprogN,R),PC),
where
Program is the security program calling the primitive function,
hprog1 . . . hprogN are equal to h(Program 1) . . . h(ProgramN),
Program1 . . . ProgramN are the security programs with which the key is to be shared,
f(.) is the random function,
h(.) is substantially a publicly available random hash function, and
o( . . . ) performs a re-ordering of the arguments outputting arguments in the order hprog1, . . . hprogR,h(Program),hprogR+1, . . . hprogN.

5. The method of claim 1, wherein the shared secret is used in a first security program to generate a proof of execution, and wherein the shared secret is used in a second security program to verify the proof of execution.

6. The method of claim 1, wherein the shared secret is used to communicate between different security programs running on the same security device.

7. The method of claim 1, wherein the security program is executed as part of a second security program (402), the second security program providing certified execution which proves to the user of the security device that the security program is executed by the security device.

8. The method of claim 1, wherein the random function comprises a complex physical system.

9. The method of claim 1, wherein the computation of the shared secret uses part of the security program input as input to the random function.

10. System (100) comprising a random function (104) and a processing device (110) comprising a processor (111) and a memory (112) for executing computer-readable instructions, the instructions being arranged for causing the system to implement the method according to claim 1.

11. Computer program product (113) having computer executable instructions for causing a computer to implement the method according to claim 1.

12. Signal carrying a shared secret generated by the method according to claim 1.
